(19) United States
(12) Patent Application Publication
(10) Pub. No.: US 2015/0088567 A1
(43) Pub. Date: Mar. 26, 2015

(54) METHODS FOR BUILDING PROJECT TEAMS AND DEVICES THEREOF

(71) Applicant: Erin Rae Lambroschini, London (GB)

(72) Inventor: Erin Rae Lambroschini, London (GB)

(21) Appl. No.: 14/032,852

(22) Filed: Sep. 20, 2013

(51) Int. Cl. G06Q 10/06

(52) U.S. Cl. CPC G06Q 10/063112; G06Q 10/063118
USPC 705/7.14

(57) ABSTRACT

A method, non-transitory computer readable medium, and a project team building device that builds a suggested team comprising members selected from a pool of candidates, wherein each of the members is associated with required skill(s) associated with a project. A list of a subset of the possible candidates organized based on a number of skills associated with the possible candidates matching required skills associated with the project is provided. The team is modified based on a received input to add possible candidate(s) from the provided list to the team or to remove member(s) from the team. The providing and modifying are repeated wherein, when member(s) are removed from the team, the list does not include the removed member(s) and is organized based on a number of skills associated with the possible candidates matching required skills of the removed member(s).

### FIELD

This technology generally relates to methods and devices for matching candidates with employers and, more particularly, methods for building project teams and devices thereof.

### BACKGROUND

Increasingly, corporate and other projects require the collaboration of a number of members of a team which each have having different skills. When putting together these looking at potential candidates, they often may have one or more skills which overlap or are redundant. Such overlapping expertise may or may not be desirable depending on the parameters (e.g., budget, timeframe, and risk) associated with a project. Unfortunately, there is no convenient way currently to build, analyze, or compare project teams based on the skills associated with potential candidates. In particular, there is no way currently to analyze or compare the completeness of a team with respect to satisfaction of required skills and/or desired redundancy of required skills among team members or prospective team members in order to facilitate generation of an optimal team for a project.

Accordingly, some project teams may have members with undesired redundancy of required skills which could be more efficient. Other project teams may have members without the desired redundancy of required skills which could jeopardize timely completion of the project. Additionally, some teams are put together with members that do not collectively have the required skill(s) necessary to complete the project.

### SUMMARY

A method for building project teams includes building, by a project team building device, a suggested team comprising members selected from a pool of possible candidates, wherein each of the members is associated with one or more of required skills associated with a project. A list of at least a subset of the possible candidates organized at least in part based on a number of skills associated with the possible candidates matching required skills associated with the project is provided by the project team building device. The team is modified by the project team building device based on a received input to add one or more of the possible candidates from the provided list to the team or to remove one or more members from the team. The providing and modifying are repeated by the project team building device wherein, when one or more members are removed from the team, the list does not include the one or more removed members and is organized at least in part based on a number of skills associated with the possible candidates matching required skills of the one or more removed members

A non-transitory computer readable medium having stored thereon instructions for building project teams comprising machine executable code which when executed by a processor, causes the processor to perform steps including building a suggested team comprising members selected from a pool of possible candidates, wherein each of the members is associated with one or more of required skills associated with a project. A list of at least a subset of the possible candidates organized at least in part based on a number of skills associated with the possible candidates matching required skills associated with the project is provided. The team is modified based on a received input to add one or more of the possible candidates from the provided list to the team or to remove one or more members from the team. The providing and modifying are repeated wherein, when one or more members are removed from the team, the list does not include the one or more removed members and is organized at least in part based on a number of skills associated with the possible candidates matching required skills of the one or more removed members.

A project team building device includes a processor coupled to a memory and configured to execute programmed instructions stored in the memory including building a suggested team comprising members selected from a pool of possible candidates, wherein each of the members is associated with one or more of required skills associated with a project. A list of at least a subset of the possible candidates organized at least in part based on a number of skills associated with the possible candidates matching required skills associated with the project is provided. The team is modified based on a received input to add one or more of the possible candidates from the provided list to the team or to remove one or more members from the team. The providing and modifying are repeated wherein, when one or more members are removed from the team, the list does not include the one or more removed members and is organized at least in part based on a number of skills associated with the possible candidates matching required skills of the one or more removed members.

This technology provides a number of advantages including methods, non-transitory computer readable medium, and a project team building device that facilitates efficient building of project teams. With this technology, a web-based platform or dashboard is provided for users to input skills required for a project and for recruiters to build teams based on skills of candidates matching skills required for a project. The web-based platform facilitates analysis of the completeness and/or redundancy of skills of potential candidates for a project team, as well as enables a comparison of various project teams to allow a recruiter to customize an optimal team appropriate for the particular project.

### BRIEF DESCRIPTION OF THE DRAWINGS

FIG. 1 is a block diagram of an exemplary network environment which incorporates candidate computing devices and a recruiter computing device coupled to an exemplary project team building device; and

FIG. 2 is a flowchart of an exemplary method for building project teams;

FIGS. 3A and 3B are tables including exemplary portions of a hierarchical taxonomy that include a plurality of selectable skills required for a project;

FIG. 4 is a table including an exemplary plurality of required skills selected for a project;

FIG. 5 is a table including an exemplary plurality of skills associated with a candidate selected for a project team associated with a project; and

FIG. 6 is a table including an exemplary plurality of skills required for a project but unmet by a candidates selected for a project team associated with the project.

### DETAILED DESCRIPTION

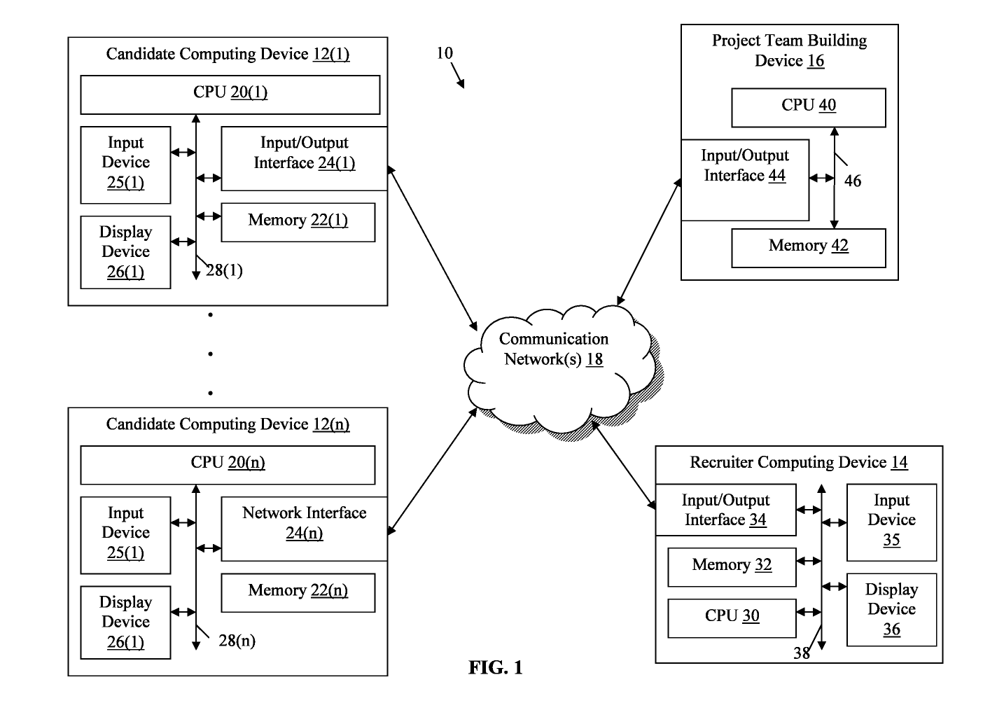

An exemplary environment 10 with candidate computing devices 12(1)-12(n) and a recruiter computing device 14 coupled to a project team building device 16 by communication network(s) 18 is illustrated in FIG. 1, although this environment 10 can include other numbers and types of systems, devices, components, and elements in other configurations. While not shown, the environment 10 also may include additional network components which are well known to those of ordinary skill in the art and thus will not be described here. This technology provides a number of advantages including methods, non-transitory computer readable medium, and a project team building device that facilitates efficient building of project teams.

The candidate computing devices 12(1)-12(n) in this example each include a central processing unit (CPU) 20(1)-20(n), a memory 22(1)-22(n), an input/output interface 24(1)-24(n), an input device 25(1)-25(n), and a display device 26(1)-26(n), which are coupled together by a bus 28(1)-28(n) or other link. The candidate computing devices 12(1)-12(n) can also have other numbers and types of systems, devices, components, and elements in other configurations and locations. Potential project team candidates can use the candidate computing devices 12(1)-12(n) to submit associated skills to the project team building device 14, as well as to exchange other information and/or perform other types and numbers of functions.

The CPU 20(1)-20(n) in each of the candidate computing devices 12(1)-12(n) executes a program of stored instructions for one or more aspects of the present technology as described and illustrated by way of the examples herein. Other types and numbers of processing devices and configurable hardware logic could be used and the CPU 20(1)-20(n) in each of the candidate computing devices 12(1)-12(n) could execute other numbers and types of programmed instructions.

The memory 22(1)-22(n) in each of the candidate computing devices 12(1)-12(n) stores these programmed instructions for one or more aspects of the present technology, as described and illustrated herein, although some or all of the programmed instructions could be stored and/or executed elsewhere. The memory 22(1)-22(n) optionally stores programmed instructions for a Web browser for communicating with the input/output interface 24(1)-24(n) to operatively exchange content with the project team building device 16. A variety of different types of memory storage devices, such as a random access memory (RAM), read only memory (ROM), floppy disk, hard disk, CD-ROM, DVD-ROM, or other computer readable medium which is read from and written to by a magnetic, optical, or other reading and writing system that is coupled to the CPU 20(1)-20(n), can be used for the memory 22(1)-22(n).

The input/output interface 24(1)-24(n) in each of the candidate computing devices 12(1)-12(n) is used to operatively couple and communicate between the candidate computing device 12(1)-12(n) and the project team building device 16 via the communication network(s) 18, although other types and numbers of connections or configurations can also be used. By way of example only, the communication network(s) 18 could use TCP/IP over Ethernet and industry-standard protocols and can include one or more local area networks or wide area networks, for example.

The input device 25(1)-25(n) in each of the candidate computing devices 12(1)-12(n) is used to enable a user to interact with the candidate computing device 12(1)-12(n), such as to input data or to configure, program, or operate the candidate computing device 12(1)-12(n) by way of example only. Input devices may include a keyboard, computer mouse, or touchscreen, for example, although other types and numbers of input devices could also be used. The display device 26(1)-26(1) in each of the candidate computing devices 12(1)-12(n) is used to enable a user to view data and information output or provided by the candidate computing device 12(1)-12(n). Display devices 26(1)-26(n) may include a computer monitor or a touchscreen, although other types and numbers of display devices could also be used.

The recruiter computing device 14 in this example includes a central processing unit (CPU) 30, a memory 32, an input/output interface 34, an input device 35, and a display device 36, which are coupled together by a bus 38 or other link. The recruiter computing device 14 can also have other numbers and types of systems, devices, components, and elements in other configurations and locations. A recruiter can use the recruiter computing device 14 to submit required skills for a project to the project team building device 14, select and remove potential candidates for a project team, view and compare previously built project teams, and to exchange other information with the project team building device 14 and/or to perform other functions.

The CPU 30 in the recruiter computing device 14 executes a program of stored instructions for one or more aspects of the present technology as described and illustrated by way of the examples herein. Other types and numbers of processing devices and configurable hardware logic could be used and the CPU 30 in the recruiter computing device 14 could execute other numbers and types of programmed instructions.

The memory 32 in the recruiter computing device 14 stores these programmed instructions for one or more aspects of the present technology, as described and illustrated herein, although some or all of the programmed instructions could be stored and/or executed elsewhere. A variety of different types of memory storage devices, such as a random access memory (RAM), read only memory (ROM), floppy disk, hard disk, CD-ROM, DVD-ROM, or other computer readable medium which is read from and written to by a magnetic, optical, or other reading and writing system that is coupled to the CPU 30, can be used for the memory 32.

The input/output interface 34 in the recruiter computing device 14 is used to operatively couple and communicate between the recruiter computing device 14 and the project team building device 16 via the communication network(s) 18, although other types and numbers of connections or configurations can also be used.

The input device 35 in the recruiter computing device 14 is used to enable a user to interact with the recruiter computing device 14, such as to input data or to configure, program, or operate the recruiter computing device 14 by way of example only. The input device may be a keyboard, computer mouse, or touchscreen, for example, although other types and numbers of input devices could also be used. The display device 36 in the recruiter computing device 14 is used to enable a user to view data and information output or provided by the recruiter computing device 14. The display device 36 may be a computer monitor or a touchscreen, although other types and numbers of display devices could also be used.

The project team building device 16 includes a central processing unit (CPU) 40, a memory 42, and an input/output interface 44, which are coupled together by a bus 46 or other link, although other numbers and types of systems, devices, components, and elements in other configurations and locations can also be used. The CPU 40 in the project team building device 16 executes a program of stored instructions for one or more aspects of the present technology as described and illustrated by way of the examples herein, although other types and numbers of processing devices and configurable hardware logic could be used and the CPU 40 could execute other numbers and types of programmed instructions.

The memory 42 in the project team building device 16 stores these programmed instructions for one or more aspects of the present technology as described and illustrated herein, although some or all of the programmed instructions could be stored and executed elsewhere. A variety of different types of memory storage devices, such as a RAM, ROM, floppy disk, hard disk, CD-ROM, DVD-ROM, or other computer readable medium which is read from and written to by a magnetic, optical, or other reading and writing system that is coupled to the CPU 40, can be used for the memory 42.

The input/output interface 44 in the project team building device 16 is used to operatively couple and communicate between the project team building device 16, the candidate computing devices 12(1)-12(n), and the recruiter computing device 14 via the communication network(s) 18, although other types and numbers of connections and configurations can also be used.

Although examples of the project team building device 16, the candidate computing devices 12(1)-12(n), and recruiter computing device 14, which are coupled together via the communication network(s) 18, are described herein, each of these systems can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any embodiment of the examples. The examples may also be implemented on computer device(s) that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, or combinations thereof.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

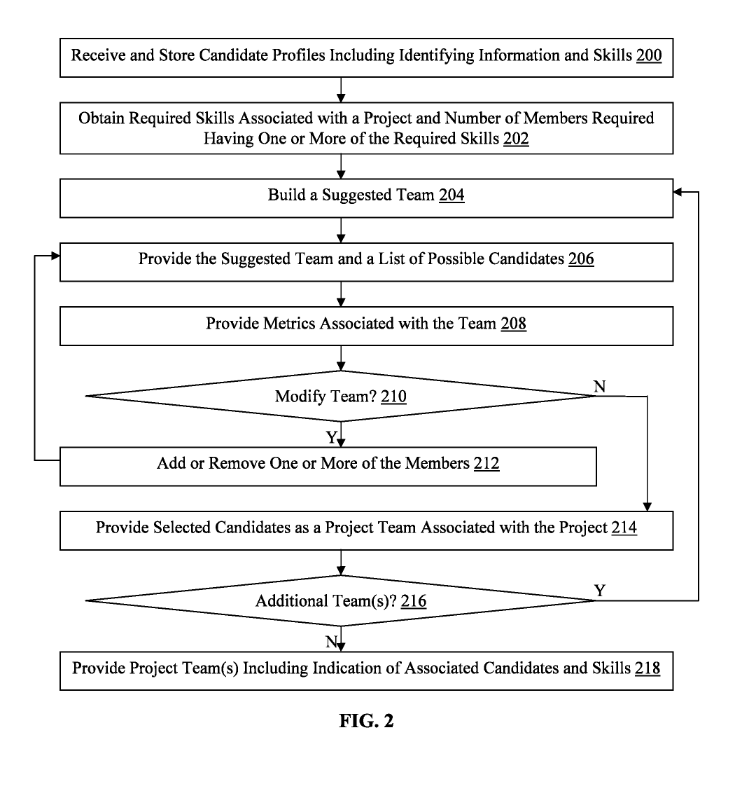

Exemplary methods and devices for building project teams will now be described with reference to FIGS. 1-6. Referring more specifically to FIG. 2, in step 200 the project team building device 16 receives, from users of the candidate computing devices 12(1)-12(n), potential or prospective team member information including identifying information and a plurality of skills. The candidate information can be stored by the project team building device 16 as a plurality of candidate profiles, collectively representing a candidate pool, in a database in the memory 42, for example, although other storage methods and locations can also be used.

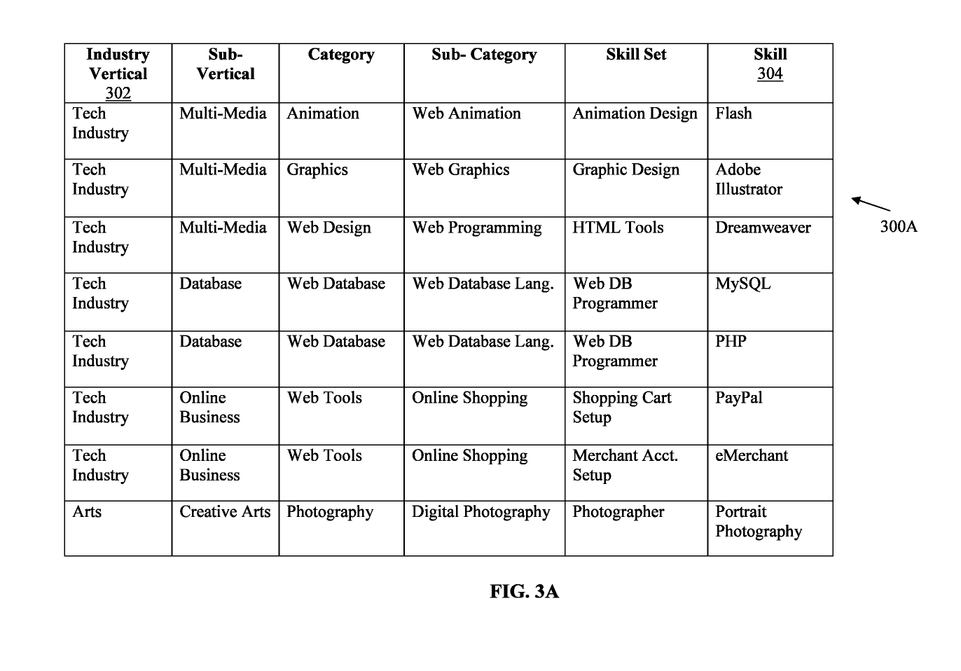

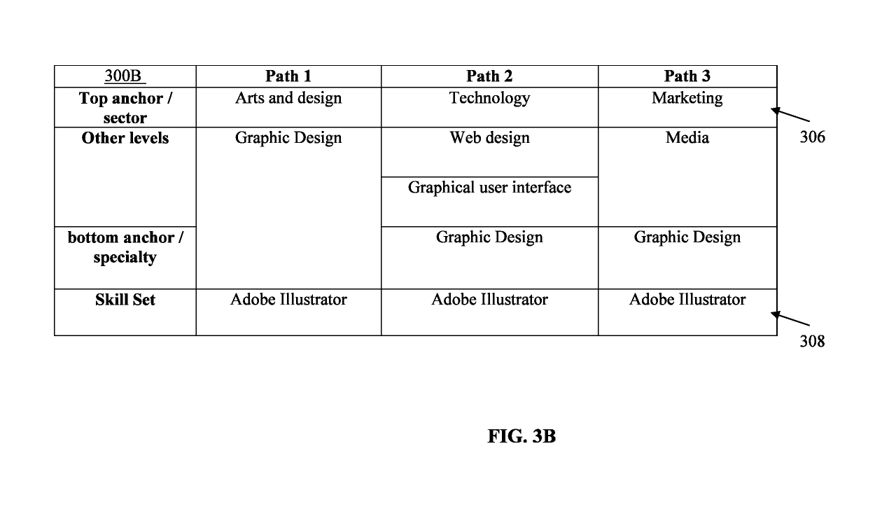

In one example, the candidate profiles can be input through form(s) requested by users of the candidate computing devices 12(1)-12(n) using a web browser executed on the candidate computing devices 12(1)-12(n). The web page forms can be stored in and provided from the memory 42 by the project team building device 16. In this example, the forms can include selectable menu(s) including an established lexicon of skills, such as illustrated in FIGS. 3A and 3B and described with reference to step 202, for example. The selectable menu(s) can also be searchable based on a keyword or natural language search submitted by a user.

In another example, users of the candidate computing devices 12(1)-12(n) send at least one document, such as a resume, which is parsed by the project team building device 16 to extract at least the identifying information and skills for each candidate. Other methods of receiving and storing candidate information can also be used.

In step 202, the project team building device 16 obtains required skills associated with a project and a required number of team members having one or more of the required skills. In this example, a user of the recruiter computing device 14 communicates with the project team building device 16 to submit login credentials and receive a new project input web page from the project team building device 16. The user of the recruiter computing device 14 can be a recruiter, employer, manager, or other representative of an organization, or any other person requiring a team to complete a project. The new project input web page can be stored in and provided from the memory 42, for example. In this example, the new project input web page includes input field(s) for the user of the recruiter computing device 14 to submit at least a name and a description of the new project.

Additionally, in this example the new project input web page includes a selectable and hierarchical menu corresponding to a taxonomy that facilitates submission by the user of the recruiter computing device 14 of required skills associated with the new project. The obtained skills required for the project in this example are based on an established taxonomy, which optionally corresponds to the taxonomy used to receive the skills from the candidates in step 200. By using the same taxonomy for the candidate skills as the skills required for the project, optimal candidates for a project team for the new project will be more likely to be located, as described and illustrated in more detail below with reference to step 204.

Exemplary portions of a taxonomy 300A and 300B are illustrated in FIGS. 3A and 3B, respectively, wherein the column 302 and row 306 represent the broadest category in the taxonomy 300A and 300B, respectively, and the column 304 and row 308 represent the possible required skills selectable by a user of the recruiter computing device 14 using the taxonomy 300A and 300B, respectively. As illustrated in FIG. 3B, a user can traverse multiple paths in the hierarchy in order to selected a skill.

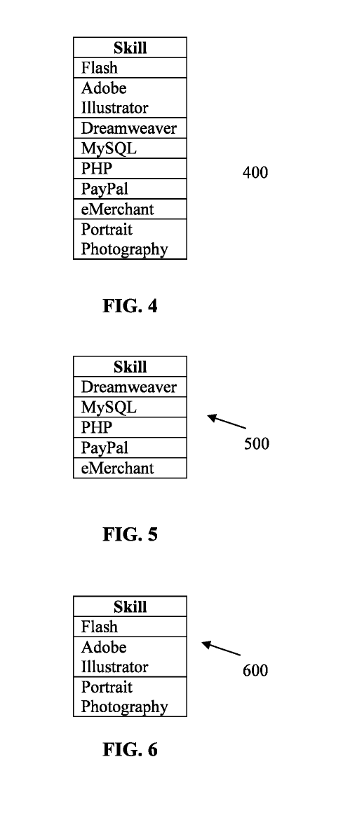

Upon selection of a required skill, the new project input web page can include an input field for receiving the required number of members having the required skill, although other methods of inputting the required skills and required number of members can also be used. In one example, a medium-sized company desires to engage in a new project of building a website having a number of features. In this example, the new project requires each of the skills 400 illustrated in FIG. 4, as obtained by the project team building device 16 in step 202, and does not require more than one member to have each of the skills.

Upon submission of all of the required skills and number of members for the project by the user of the recruiter computing device 14, in step 204, the project team building device 16 builds and outputs a suggested team. In order to build the suggested team, the project team building device 16 searches the candidate profiles stored in the memory 42 in step 200 for candidates in the pool that are associated with a plurality of skills, a subset of which includes at least one of the required skills obtained in step 202.

When the same skills lexicon is used to receive candidate profiles as required skills for the project, the search parameters including the required skills obtained in step 202 will match the candidate skills received in step 200. In this example, when none or not enough of the candidates are associated with one or more of the required skills, the project team building device 16 adds a candidate to the team based on a closest match. A closest match can be determined based on a match of a skill in a same or closest hierarchical category as the one or more unsatisfied required skills, for example, although other methods of determining a closest match can also be used.

Also optionally, the project team building device 16 can build the suggested team using the least number of candidates that satisfy all of the required skills and required number of members, although other methods of building the suggested team can also be used. Additionally, when multiple candidates are associated with skills matching the same number of required skills, other parameters associated with the candidates and stored in the candidates profile can be used to select a subset of the equivalent candidates for the suggested team. For example, the project team building device 16 can obtain the number of years of experience candidates have with respect to the associated skills and store the experience level along with the candidate profiles in step 200. The experience level can then be used to select between equivalent candidates. Other candidates profile information can also be obtained and used to select between candidates with an equivalent number of the required skills.

In step 206, the project team building device 16 provides the suggested team and the list of possible candidates to the recruiter computing device 14, such as by outputting the suggest team and the list to a results web page, for example. In this example, the results web page includes at least identifying information for the candidates included in the list and members of the suggested team, which corresponds to the identifying information received and stored in step 200.

Optionally, the results web page further includes an indication of all the skills associated with each of the candidates and team members. Also optionally, the list of candidates is organized based on a number of the skills associated with each of the candidates matching the required skills so that candidates meeting the most required skills are displayed near the top of the list. Additionally, other candidate information (e.g., languages or job type) can be input in step 202 and used to filter the candidates included in the list of candidates based on additional candidate information received in step 200.

In step 208, the project team building device 16 optionally determines and provides metric(s) and context information associated with the project team. In one example, the project team building device 16 determines and provides a completeness score metric which can be a percentage of the required skills that are met by the team members. In another example, the project team building device 16 optionally determines and provides an indication of the skills required for the new project that are met by the team members.

In yet another example, the project team building device 16 optionally determines and provides an indication and/or a number of redundant or overlapping skills associated with the team members. The identified redundant skills can be required skills and/or skills not required by the new project but associated with the team members. The project team building device 16 can output the metrics and context information determined in step 208 on the results web page or on another web page, such as in the form of a dashboard for example, that is provided to the recruiter computing device 14, although other display methods can also be used.

Optionally, the project team building device 16 further determines, in step 208, whether any of the team members are redundant based on the respective associated skills. Accordingly, if all of the required skills for any one of the team members are satisfied by one or more other of the team members, then the one of the team members can be considered redundant, depending on the required number of team members having the one or more required skills obtained in step 202. In a first iteration, the project team building device 16 will necessarily determine that none of the members of the suggested team are redundant.

However, if the project team building device 16 determines that any of the team members are redundant, such as in a second or subsequent iteration, then the project team building device 16 also provides, in step 208, an indication of the redundant member(s). Depending on the requirements of the new project and/or the preferences of the user of the recruiter computing device 14, it may be desirable to include the redundant member(s) in the project team or to remove the redundant member(s) from the project team. Additionally, the user of the recruiter computing device 14 may want to remove a member for having only a subset of required skills that overlap with other candidate(s) as indicated in step 208, or for any other reason based on the metrics and/or context information provided in step 208.

In step 210, the project team building device 16 determines whether an input to modify the suggested team is received from the user of the recruiter computing device 14. The input can be in the form of a selection of one of the candidates in the list for inclusion in the team or selection of one of the team members to be removed from the team.

In one example, the results web page includes a drag-and-drop feature which allows the user of the recruiter computing device 14 to drag an element of the results web page associated with a candidate included in the list to a designated area of the results web page, such as a project team folder, for example. A similar drag-and-drop feature can be provided to allow the user of the recruiter computing device 14 to remove a member from the team, although other methods of submitting a selection of one of the candidates included in the list or one of the members of the team can also be used.

If the project team building device 16 determines in step 210 that an input to modify the suggested team is received, then the Yes branch is taken to step 212. In step 212, the project team building device 16 adds one or more of the candidates to the project team or removes one or more members of the project team, based on the input to modify the suggested team. In this example, a member is removed from the team by the user of the recruiter computing device 14 leaving team members associated with required skills 500 illustrated in FIG. 5, which is a subset of the required skills for the project illustrated in FIG. 4.

Subsequent to adding a candidate from the list to the team or removing a member from the team, the project team building device 16 proceeds back to step 206, and the team and the list of possible candidates is provided to the recruiter computing device 14 as described and illustrated earlier. If no members were removed in step 210, the list can be organized as described and illustrated earlier with reference to step 206.

However, in this subsequent iteration of step 206, the list can also be organized based on a number of skills associated with the possible candidates matching required skills of any members removed in step 210 or otherwise unmet by the current team members. Accordingly, possible candidates associated with skills matching required skills of the removed members, or otherwise unsatisfied by the team, can be ranked higher in the list. Additionally, any removed members can optionally be excluded from the list. In this example, the skills 600 illustrated in FIG. 6 are unmet based on the member removed from the team in step 212.

Accordingly, steps 206-212 can be repeated by the project team building device 16 as described and illustrated earlier to allow the user of the recruiter computing device 14 to build a desired team. Referring back to step 210, if the project team building device 16 determines that an input to modify the project team is not received in any iteration, then the No branch is taken to step 214. In one example, the user of the recruiter computing device 14 can indicate to the project team building device 16, such as through interaction with a project team complete button for example, that no more modifications are to be made to the team. Other conditions and metrics can also be used in order to indicate to the project team building device 16 that the project team is complete in step 210.

In step 214, the project team building device 16 provides the selected candidates as a project team associated with the project. The project team building device 16 can store the selected candidates as a project team such as by associating the candidate profiles in the memory 42 with a unique project team identifier associated with a unique identifier for the new project, for example, although other storage methods can also be used. Optionally, the project team building device 16 also stores the metrics and context information associated with the project team, as determined and provided in the last iteration of step 208, as associated with the project team in the memory 42.

In step 216, the project team building device 16 determines whether the user of the recruiter computing device 14 would like to build an additional team for the new project. Accordingly, the user can begin the process of building a new project team by interacting with a new project team button in the results web page, for example, which is configured to send a request to build a new project team to the project team building device 16, although other methods of indicating that an additional team will be built for the project can be used.

Upon receiving the request, or otherwise determining in step 216 that the user of the recruiter computing device 14 would like to build an additional team, the Yes branch is taken to step 204 and the project team building device 16 builds and outputs a suggested team, as described and illustrated earlier. Accordingly, steps 204-216 can optionally be repeated to allow the user of the recruiter computing device 14 to build a plurality of teams for a project.

In one example, the user can indicate that no additional project teams will be built by interacting with a compare project teams button, for example, which is configured to send a request to compare the project teams built for the new project to the project team building device 16. Upon receiving the request, or otherwise determining in step 216 that the user of the recruiter computing device 14 would not like to build an additional team, the No branch is taken to step 218.

In step 218, the project team building device 16 provides the project team(s) associated with the new project including an indication of the candidates and/or skills associated with each of the project team(s). The project team information can be retrieved from the memory 42 and output to a team comparison web page that is sent by the project team building device 16 to the recruiter computing device 14, for example. The built project teams can include various combinations of candidates having various associated skills. Accordingly, the teams can also have varying metrics and context information, as determined in step 208, for example, which are also optionally retrieved from the memory 42 and included in the team comparison web page provided by the project team building device 16.

Using the team comparison web page, the user of the recruiter computing device 14 can compare various project teams for the new project to determine the optimal combination of candidates. In some examples, candidate interest, interview results, and availability conflicts can require removal of otherwise optimal candidates from a project team. In these examples, a user of the recruiter computing device 14 can communicate with the project team building device 16 to remove one or more candidates and optionally add one or more candidates to a previously provided project team.

Candidates can be removed or added by submitting authenticated login credentials and a request to edit a previously built project team to the project team building device 16. In response to the request, the project team building device 16 can build and send to the recruiter computing device 14 a results web page based on the information for the previously built project team stored in the memory 42. Upon sending the results web page, the project team building device 16 can perform steps 206-214, with respect to the previously built project team. Alternatively, in these examples, the user of the recruiter computing device 14 can build a new project team for the project, as described and illustrated earlier.

By this technology, project teams can be built that include members having various required and other skills to assist employers or recruiters, for example, in building an optimal team for a project. Various metrics and context information including completeness and redundancy can be generated and output for a plurality of teams built for a project thereby advantageously providing a quantitative comparison of the project teams. Accordingly, with this technology, an optimal team of candidates can be selected that satisfies all or a threshold number of required skills as well as represents reduced or increased skill redundancy, according to the needs and parameters of the associated project.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for building project teams, the method comprising:
building, by a project team building device, a suggested team comprising members selected from a pool of possible candidates, wherein each of the members is associated with one or more of required skills associated with a project;
providing, by the project team building device, a list of at least a subset of the possible candidates organized at least in part based on a number of skills associated with the possible candidates matching required skills associated with the project;
modifying, by the project team building device, the team based on a received input to add one or more of the possible candidates from the provided list to the team or to remove one or more members from the team;
repeating, by the project team building device, the providing and modifying wherein, when one or more members are removed from the team, the list does not include the one or more removed members and is organized at least in part based on a number of skills associated with the possible candidates matching required skills of the one or more removed members.

2. The method of claim 1, further comprising receiving, with the project team building device, the required skills associated with the project and a required number of members associated with one or more of the required skills.

3. The method of claim 2, wherein the receiving the required skills associated with the project further comprises providing, with the project team building device, a hierarchical menu including an established lexicon of the required skills, the lexicon of required skills corresponding to a lexicon used to receive one or more skills associated with each of the potential candidates.

4. The method of claim 1, further comprising providing, with the project team building device, one or more of an indication of a percentage of the required skills met by each of the possible candidates or an indication of the required skills met by each of the possible candidates.

5. The method of claim 1, wherein the providing and modifying are repeated until a received input indicates the team is complete.

6. The method of claim 1, further comprising providing, with the project building team, an indication of the required skills which are redundant between the members of the team.

7. The method of claim 1, further comprising:
determining, with the project team building device, when the required skills of one of the members of the team is satisfied by one or more other members of the team; and
outputting, with the project team building device, an indication of the one of the members of the team based on the determination that the required skills of the one of the members of the team is satisfied by one or more other of the members of the team.

8. A non-transitory computer readable medium having stored thereon instructions for building project teams comprising machine executable code which when executed by a processor, causes the processor to perform steps comprising:
building a suggested team comprising members selected from a pool of possible candidates, wherein each of the members is associated with one or more of required skills associated with a project;
providing a list of at least a subset of the possible candidates organized at least in part based on a number of skills associated with the possible candidates matching required skills associated with the project;
modifying the team based on a received input to add one or more of the possible candidates from the provided list to the team or to remove one or more members from the team;
repeating the providing and modifying wherein, when one or more members are removed from the team, the list does not include the one or more removed members and is organized at least in part based on a number of skills associated with the possible candidates matching required skills of the one or more removed members.

9. The medium of claim 8, further having stored thereon instructions that when executed by the processor cause the processor to perform steps further comprising receiving the required skills associated with the project and a required number of members associated with one or more of the required skills.

10. The medium of claim 9, wherein the receiving the required skills associated with the project further comprises providing a hierarchical menu including an established lexicon of the required skills, the lexicon of required skills corresponding to a lexicon used to receive one or more skills associated with each of the potential candidates.

11. The medium of claim 8, further having stored thereon instructions that when executed by the processor cause the processor to perform steps further comprising providing one or more of an indication of a percentage of the required skills met by each of the possible candidates or an indication of the required skills met by each of the possible candidates.

12. The medium of claim 8, wherein the providing and modifying are repeated until a received input indicates the team is complete.

13. The medium of claim 8, further having stored thereon instructions that when executed by the processor cause the processor to perform steps further comprising providing an indication of the required skills which are redundant between the members of the team.

14. The medium of claim 8, further having stored thereon instructions that when executed by the processor cause the processor to perform steps further comprising:
determining when the required skills of one of the members of the team is satisfied by one or more other members of the team; and
outputting an indication of the one of the members of the team based on the determination that the required skills of the one of the members of the team is satisfied by one or more other of the members of the team.

15. A project team building device, comprising:
a processor coupled to a memory and configured to execute programmed instructions stored in the memory comprising:
building a suggested team comprising members selected from a pool of possible candidates, wherein each of the members is associated with one or more of required skills associated with a project;
providing a list of at least a subset of the possible candidates organized at least in part based on a number of skills associated with the possible candidates matching required skills associated with the project;
modifying the team based on a received input to add one or more of the possible candidates from the provided list to the team or to remove one or more members from the team;
repeating the providing and modifying wherein, when one or more members are removed from the team, the list does not include the one or more removed members and is organized at least in part based on a number of skills associated with the possible candidates matching required skills of the one or more removed members.

16. The device of claim 15, wherein the processor is further configured to execute programmed instructions stored in the memory further comprising receiving the required skills associated with the project and a required number of members associated with one or more of the required skills.

17. The device of claim 16, wherein the receiving the required skills associated with the project further comprises providing a hierarchical menu including an established lexicon of the required skills, the lexicon of required skills corresponding to a lexicon used to receive one or more skills associated with each of the potential candidates.

18. The device of claim 15, wherein the processor is further configured to execute programmed instructions stored in the memory further comprising providing one or more of an indication of a percentage of the required skills met by each of the possible candidates or an indication of the required skills met by each of the possible candidates.

19. The device of claim 15, wherein the providing and modifying are repeated until a received input indicates the team is complete.

20. The device of claim 15, wherein the processor is further configured to execute programmed instructions stored in the memory further comprising providing an indication of the required skills which are redundant between the members of the team.

21. The device of claim 15, wherein the processor is further configured to execute programmed instructions stored in the memory further comprising:
determining when the required skills of one of the members of the team is satisfied by one or more other members of the team; and
outputting an indication of the one of the members of the team based on the determination that the required skills of the one of the members of the team is satisfied by one or more other of the members of the team.
